(19) United States
(12) Patent Application Publication
(10) Pub. No.: US 2025/0252579 A1
(43) Pub. Date: Aug. 7, 2025

(54) REAL-TIME SEGMENTATION AND TRACKING OF OBJECTS

(71) Applicant: FD IP & LICENSING LLC, Los Angeles, CA (US)

(72) Inventors: Chia-Hsun CHUANG, Los Angeles, CA (US); Brandon FAYETTE, Los Angeles, CA (US); Gene REDDICK, San Francisco, CA (US)

(21) Appl. No.: 19/045,228

(22) Filed: Feb. 4, 2025

Related U.S. Application Data
(60) Provisional application No. 63/549,801, filed on Feb. 5, 2024.
(60) Provisional application No. 63/642,094, filed on May 3, 2024.

(51) Int. Cl. G06T 7/11; G06T 7/215; G06T 7/246; G11B 27/036

(52) U.S. Cl. CPC G06T 7/11; G06T 7/215; G06T 7/246; G11B 27/036; G06T 2200/24; G06T 2207/10016; G06T 2207/20104

(57) ABSTRACT

Examples are disclosed herein for segmentation and tracking of objects. A method can include receiving frames of a scene that includes an object, generating a first bounding box so that the object in a first frame of the frames is within the first bounding box, providing a first prompt based on the first bounding box, segmenting the object from the first frame based on the first prompt to provide a first mask, generating a second bounding box so that the object in a second frame of the frames is within the second bounding box based on the first mask, providing a second prompt based on the second bounding box, and segmenting the object from the second frame based on the second prompt to provide a second mask.

### CROSS-REFERENCE TO RELATED APPLICATIONS

This application claims priority to U.S. Patent Application No. 63/549,801, filed on Feb. 5, 2024, and U.S. Patent Application No. 63/642,094, filed on May 3, 2024, the disclosures of which are incorporated here by reference.

### FIELD OF THE DISCLOSURE

This disclosure relates generally to segmentation and tracking of objects, and more particularly, to a system and method for tracking objects for use in real-time applications.

### BACKGROUND OF THE DISCLOSURE

Segmentation is a computer vision task that involves identifying and outlining each distinct object in an image or frame. Unlike object detection, which simply locates objects with bounding boxes, instance segmentation recognizes the precise shape of each object, allowing for detailed understanding and separation of objects, even when they overlap.

### SUMMARY OF THE DISCLOSURE

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of this summary is to present some concepts of the disclosure in a simplified form prior to the more detailed description that is presented hereinafter.

In an example, a computer-implemented method can include receiving frames of a scene that includes an object, generating a first bounding box so that the object in a first frame of the frames is within the first bounding box, providing a first prompt based on the first bounding box, segmenting the object from the first frame based on the first prompt to provide a first mask, generating a second bounding box so that the object in a second frame of the frames is within the second bounding box based on the first mask, providing a second prompt based on the second bounding box, and segmenting the object from the second frame based on the second prompt to provide a second mask.

In another example, a computer-implemented method can include receiving a video of a scene or frames of the video of the scene, generating a first mask for an object in a first frame of the frames, the first mask being generated based on a first segmentation of the object from the first frame using a first prompt, generating a second mask for the object in a second frame of the frames, the second mask being generated based on a second segmentation of the object from the second frame using a second prompt, the second prompt being generated based on the first mask, and generating augmented video based on the video, the first and second mask, and a digital asset.

In yet another example, a system that includes one or more computing platforms can be configured to receive frames of a scene, the frames including an object, generate a first bounding box so that the object in a first frame of the frames is within the first bounding box, provide a first prompt based on the first bounding box, segment the object from the first frame based on the first prompt to provide a first mask, generate a second bounding box so that the object in a second frame of the frames is within the second bounding box based on the first mask, provide a second prompt based on the second bounding box, and segment the object from the second frame based on the second prompt to provide a second mask, wherein the object is segmented from the first and second frames using a segment anything model (SAM).

### BRIEF DESCRIPTION OF THE DRAWINGS

Embodiments are described with reference to the accompanying drawings. In the drawings, like reference numbers can indicate identical or functionally similar elements. The drawing in which an element first appears is generally indicated by the left-most digit in the corresponding reference number.

FIG. 1 is a block diagram of a segmentation and tracking system.

FIG. 2 is a block diagram of a system for providing augmented video.

FIG. 3 is an example of a portion of pseudocode.

FIG. 4 is another example of a portion of pseudocode.

FIGS. 5-6 are examples of result tables.

FIG. 7 is an example of a method for segmentation and tracking of an object.

FIG. 8 is an example of a method for generating augmented video.

FIG. 9 is a block diagram of a computing environment that can be used to perform one or more methods according to an aspect of the present disclosure.

FIG. 10 is a block diagram of a cloud computing environment that can be used to perform one or more methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Examples are disclosed herein relating to segmentation and tracking. Advancements in Augmented Reality (AR) have allowed for seamless integration of virtual assets into real-world scenes, especially in the realm of film production. A typical virtual effects (VFX) production process involves filming live actors first, and then integrating virtual assets (e.g., virtual actors or elements) during post-production. Pre-visualization (or “pre-viz”), is a technique used in filmmaking to create a rough, animated version of a final sequence that gives a director an estimate of what the digital asset will look like, where it will be positioned, and how it will behave. For example, a previsualization system as described in U.S. Pat. No. 11,682,175, and titled “Previsualization Devices and Systems for the Film Industry,” filed Aug. 24, 2021, (“the '175 Patent”) which is incorporated herein by reference in its entirety can be used for creating an augmented video with the digital asset animated therein. The previsualization system enables the director to have a “good enough” shot of a scene with the digital asset so that production issues (e.g., where the actor should actually be looking, where the digital asset should be located, how the digital asset should behave, etc.) can be corrected during filming (rather than post-production) and thus at a production stage. The previsualization system can implement digital compositing to provide composited frames with the digital asset embedded therein. Pre-viz enables the director and other personnel (e.g., camera team) to witness virtual assets in real time, that is, during production (e.g., filming of movies, TV shows, etc.). Thus, by using pre-viz, filming quality can be enhanced, even though on-set actors may not see the digital assets without the aid of AR glasses.

Achieving a seamless integration of digital assets (virtual assets) into real-world video footage of the scene (e.g., in a way that the digital assets and real-world video footage appear to naturally exist within that space) depends on an effectiveness of occlusion and shadow casting. Occlusion occurs when a real-world object blocks part of a digital asset from view, makes the digital asset appear to exist behind it, the digital asset blocks a view of another digital asset, or the digital asset blocking the real-world object. Shadow casting involves creating shadows for the virtual assets that mimic how real objects cast shadows under same lighting conditions. Proper shadowing makes virtual assets appear grounded in the scene, enhancing their believability. Shadows help in establishing the location and relationship of light sources to the virtual elements, further embedding them into the real-world context. Occlusion is particularly persuasive because it aligns with our everyday experience of how objects interact with each other in a three-dimensional space. Thus, occlusion and shadow casting specify or drive an interaction between virtual assets and the real world. Of the two, occlusion is often more persuasive, as it convincingly shows virtual assets partially hidden by real-world objects.

A common occlusion technique used during film production involves the use of green or blue screens, which results in an entire background of the scene being virtual, including the digital assets. Nevertheless, this approach has its limitations, such as color spill, limited realism, etc. Another occlusion technique leverages segmentation. This technique involves digitally isolating elements (e.g., an actor, object, etc.) within the scene so that digital assets can be inserted either in front of or behind these elements to achieve an occlusion effect.

Traditional segmentation, such as used during film production for pre-viz digital compositing (e.g., generation of real-world video footage with one or more digital assets), is limited in types of objects that can accurately be segmented due to a way a segmentation model is trained. Traditional segmentation models are trained on datasets that contain specific categories of objects. The segmentation model learns to recognize and segment only those categories it has been trained on. When presented with objects outside of those categories, the model struggles to accurately segment new objects because it has no prior knowledge or understanding of those objects. To achieve high accuracy, traditional segmentation models require large datasets with detailed annotations (e.g., object outlines). Collecting and annotating these datasets for a wide range of object types is time-consuming and resource-intensive. Thus, an accuracy of segmentation models is limited to the objects on which it has been trained.

To address the limitations of traditional segmentation models, a segment anything model (SAM) has been proposed. The SAM can perform zero-shot segmentation (or transfer), that is, segment any object from any frame. The SAM can perform segmentation tasks on objects and image types it has never encountered during its training phase. The SAM is trained on a vast and diverse dataset (e.g., over 1 billion masks from approximately 11 million licensed and privacy-respecting images). This extensive training enables the SAM to perform both interactive and automatic segmentation tasks across a wide range of objects and scenes. In an interactive mode, the SAM allows users to directly guide the segmentation process through input prompts. These prompts can be as simple as a click on the object of interest within a frame, drawing a bounding box around it, or providing a more descriptive input such as a freeform text. In an automatic mode, the SAM can identify and segment all objects within the frame without user intervention. The automatic mode relies on a SAM's training to recognize and create masks for objects in an image (or frame). While SAMs are more effective than traditional segmentation techniques, SAM's relatively large model size makes it unsuitable for real-time applications, such as pre-viz digital compositing. To overcome the challenges that the SAM model poses for real-time applications, alternative SAM type models have been developed, such as fast SAM (FastSAM) and mobile-friendly SAM (MobileSAM). FastSAM can process frames at a rate of about 50 times faster than SAM, while MobileSAM can process frames at a rate of about 250 times faster and has a compact model size of under 10 megabytes (MB), which makes it suitable for mobile applications (e.g., AR mobile applications).

Although SAM is capable of segmenting a wide range of objects, there are often scenarios where segmentation of specific objects is desired. In such scenarios, inputs, referred to as “prompts,” are provided. Prompts can take various forms, including textual descriptions, clicks, bounding boxes, or any form of input that can specify or highlight the object of interest within a frame. For instance, if a task is to segment all dogs in the frame, a prompt could explicitly state “dog” as the object of interest or could be a bounding box can be drawn around the dog in the frame to provide an indication to the SAM which part of the frame to focus on for segmentation.

In some instances, an object detection model is used to generate bounding boxes as prompts for SAMs. The object detection model is used with the SAM to automate a process of detecting objects (e.g., identifying and locating objects of interest) and tracking the detected objects within frames. These models are capable of scanning a frame (image) and generating bounding boxes around detected objects to identify where those objects are located. Once the object detection model has identified and located an object (or objects) within the frame, resulting bounding boxes can serve as prompts for the SAM. The bounding boxes and class labels (e.g., identifying a type of object) generated by the object detection model acts as prompts or inputs for a tracking phase. Thus, the object detection model operates as a preliminary step, guiding the SAM on where to perform segmentation by providing it with specific areas of the image to focus on. The SAM then segments these objects from the frame. The SAM creates a mask for each object to provide mask information. After objects are segmented in the frame, each detected and segmented object is assigned a unique identifier for object tracking. The identifier and the mask information is provided to a tracking algorithm. The tracking algorithm is used to maintain a continuity of object identity across subsequent frames in a video using the identifier and the mask information for that object. The tracking algorithm takes the identified objects in the video as input to track the movement and behavior of objects over time.

Use of object detection models has its drawbacks. First, use of object detection models can negatively impact performance, causing a slowdown in processing speed. This limitation in real-time applications, such as pre-viz digital compositing, is important as a shot with a digital asset needs to feel as life-like as possible and in a shortest amount of time, as possible. Object detection models analyze an entire image (frame) to locate and identify objects in each subsequent frame, which involves a significant amount of computation as this step is repeated for each frame in which the object of interest is present. This step adds to a total processing time because it must be completed before the segmentation model (e.g., SAM) can begin its task. The total processing time for segmentation is a function of an amount of time it takes to detect objects (referred to as a first amount of time), and an amount of time it takes to segment the objects (referred to as a second amount of time). In real-time applications, such as pre-viz digital compositing, a segmentation total processing time needs to be under a segmentation total processing time threshold (e.g., measured in milliseconds) to ensure a seamless user experience. Any additional processing time contributes to latency, making it challenging to meet stringent speed requirements of these applications. Second, a diversity of segmented classes is restricted by limitations of the object detection models. Object detection models are typically trained on predefined datasets that contain specific object classes. These classes are chosen based on a dataset, often focusing on objects that are commonly found or deemed important for a wide range of applications. This training approach inherently limits the object detection model to only recognize and detect objects for which it has been trained. Consequently, when such models are used to generate prompts for segmentation models, the range of objects that can be accurately segmented is also limited to those known classes.

While using text prompts can potentially expand the range of segmented objects, it remains limited when dealing with objects that are challenging to describe textually. Some objects are difficult to describe accurately and unambiguously in text. Different people might use different descriptions for the same object, or a single term can refer to multiple distinct objects, leading to confusion about what exactly needs to be segmented. Certain objects or scenes can have complex visual features that are hard to capture in a textual description. This complexity can make it challenging for the segmentation model to understand and accurately segment the intended object based on text prompts alone.

Examples are disclosed herein relating to object segmentation and tracking An object can include, but not limited to, a person, animal, vehicle, tree. The term “object” as used herein can refer to anything that can be segmented from a frame and/or tracked across frames. According to the examples herein, one or more objects can be segmented and tracked that allows for real-time applications, such as pre-viz digital compositing to deliver user content or provide a seamless user experience. Using an object segmentation and tracking technique, as disclosed herein, augmented video can be generated in an appreciable amount of time (e.g., in an amount of time that is less than a segmentation total processing time threshold) that provides more appreciable (e.g., life like) AR experience, for example, for a user (e.g., director in context of film production).

By way of example, before recording (e.g., filming of a scene) while on set or site, an initial frame from a camera can be received and an object of interest within that frame can be specified. Once recording starts, video from the camera can be provided to a SAM. The SAM can detect the object of interest (that is segment the object of interest from the frame) and track the object of interest in a current frame, using mask information for one or more previous frames. Unlike traditional tracking methods that rely on an object detection model for identifying objects and then tracking of the objects by finding connections (e.g., feature connections, such as color of an object (a car) between frames) in a tracking phase, the segmentation and tracking technique, as disclosed herein, omits use of the object detection model in the tracking phase (e.g., tracking the object in subsequent frames). Because of real-time capabilities of FastSAM and MobileSAM, which can achieve frame rates larger than 24 frames per second (FPS), and the elimination of the object detection model from the tracking phase, the segmentation and tracking technique, as disclosed herein, can perform real-time segmentation and tracking of a wide range of objects in an appreciable amount of time for use in real-world applications, such as pre-viz digital compositing.

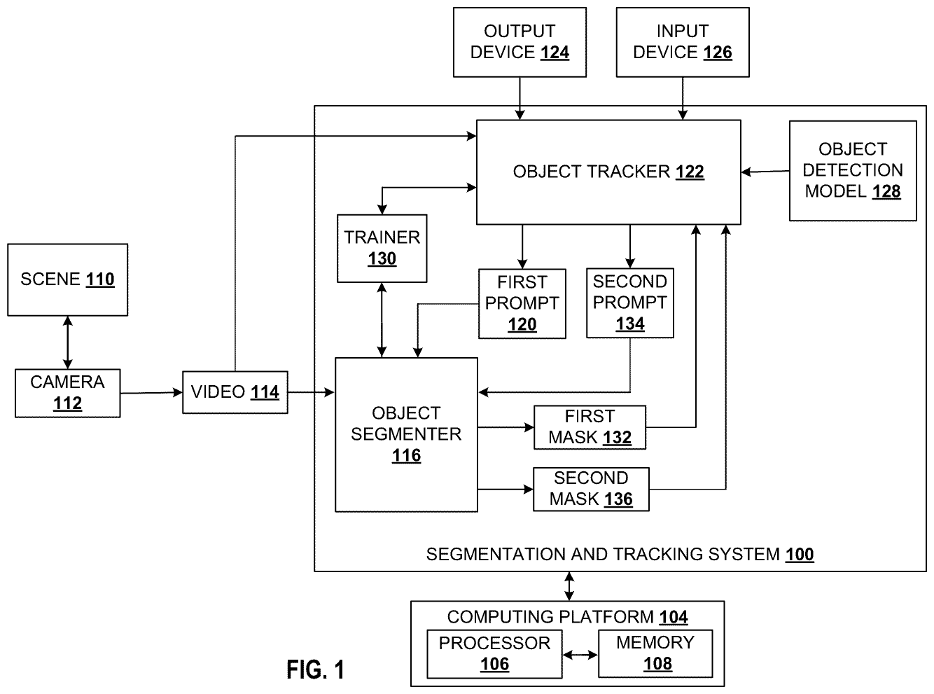

FIG. 1 a block diagram of a segmentation and tracking system 100 that can be used to track an object in a video 114. To track the object in the video 114, the object is first identified and located in the video 114. The video 114 can be composed of frames (e.g., video frames or still images) depicting a scene 110 that has been captured by a camera 112. The term “frame” and “image” can be used interchangeably in this disclosure. By way of example, the scene 110 can be an environment that the camera 112 captures (e.g., encompassing anything within a field of view (FOV) of the camera 112). Thus, the scene 110 can include a film set or location. The system 100 can be implemented using one or more modules, shown in block form in the drawings. The one or more modules can be in software or hardware form, or a combination thereof. In some examples, the system 100 can be implemented as machine readable instructions for execution on one or more computing platforms 104 (referred to as a computing platform herein), as shown in FIG. 1. The computing platform 104 can include one or more computing devices selected from, for example, a desktop computer, a server, a controller, a blade, a mobile phone, a tablet, a laptop, a personal digital assistant (PDA), and the like. The computing platform 104 can include a processor 106 and a memory 108. By way of example, the memory 108 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 106 can be implemented, for example, as one or more processor cores. The memory 108 can store machine-readable instructions that can be retrieved and executed by the processor 106 to implement the system 100. Each of the processor 106 and the memory 108 can be implemented on a similar or a different computing platform. The computing platform 104 can be implemented in a cloud computing environment (for example, as disclosed herein) and thus on a cloud infrastructure. In such a situation, features of the computing platform 104 can be representative of a single instance of hardware or multiple instances of hardware executing across the multiple of instances (e.g., distributed) of hardware (e.g., computers, routers, memory, processors, or a combination thereof). Alternatively, the computing platform 104 can be implemented on a single dedicated server or workstation.

The system 100 includes an object segmenter 116 to segment an object of interest from each frame of the video 114 that contains the object of interest. The object segmenter 116 can be implemented as a SAM. In some examples, the object segmenter 116 includes a FastSAM and can include a convolution neural network (CNN) and a lightweight prompt-guided mask decoder. The CNN can generate segment proposals for one or more objects and the decoder can be used to select a desired proposal using one or more prompts, as disclosed herein. In yet other examples, the object segmenter 116 includes a MobileSAM that includes a lightweight encoder that uses knowledge distillation for selecting at the decoder the desired proposal. In some examples, the object segmenter 116 includes a high-quality segment anything model (HQ-SAM). The HQ-SAM allows for improved SAM's masking quality through use of hierarchical queries. The HQ-SAM can generate high-resolution masks by initially making a low-resolution prediction, then querying local regions iteratively to refine details. This hierarchical approach allows the HQ-SAM to capture fine structures while remaining efficient.

The object segmenter 116 can segment the object of interest from a first frame (e.g., an initial frame) of the video 114 based on a first prompt 120. The first frame can be an initial frame of the video 114 (e.g., Frame 1) or a different frame of the video 114 (e.g., Frame 10). Each prompt provided by the object tracker 122 can identify an area within a frame or location of an object of interest in the frame for segmentation. In some examples, the respective frame is an initial frame. The first prompt 120 can be provided by an object tracker 122 based on user input at an input device 126. The prompt 120 can include information identifying points or a bounding box. The prompt 120 can specify coordinates for the bounding box with respect to a frame or identify a segment that is an area of interest within the frame.

For example, the object tracker 122 can receive (or extract) the first frame from the video 114, which can be stored in the memory 108 in some instances. In some examples, the object tracker 122 can retrieve the first frame from the memory 108. The object tracker 122 can provide a graphical user interface (GUI) that can be rendered on an output device 124 (e.g., a display) based on the first prompt 120. The GUI can include the first frame with graphical elements for creating (or defining) an initial bounding box around the object of interest in the first frame. For example, the user can use an input device 126 (e.g., a keyboard, a mouse, a touch-screen input element, a combination of input devices, etc.) to create the initial bounding box around the object of interest in the first frame. The object tracker 122 can provide the prompt 120 based on the created initial bounding box. For example, before a director, during film production, on set says “Action”, the object tracker 122 can be invoked by the user to manually define each initial bounding box for each object of interest that is to be segmented from the video 114. In some examples, the object tracker 122 employs or uses an object detection model 128. The object tracker 122 can use the object detection model 128 to locate each object of interest (for which the object detection model 128 has been trained to detect) in each frame and create the initial bounding box around that object of interest to provide the first prompt 120. Thus, in some examples, a prompt can identify a number of bounding boxes corresponding to areas or portions of a frame at which an object of interest is located. In some examples, if depth information is available for the scene 110, the depth information can be used by the object tracker 122 to provide the prompt 120. For example, the depth information can indicate a distance of each pixel in an image from the camera 112. Thus, the depth information can characterize a distance of an object in the scene 110 relative to the camera 112. The depth information can be used to identify foreground objects (e.g., elements in the scene 110 that are positioned closest to the camera 112). Thus, the prompt 120 can be provided for segmentation of one or more foreground objects for digital composition (e.g., generation of augmented video). The prompt 120 allows for the correct placement of digital assets with respect to the identified foreground object.

The object detection model 128 can be trained by a trainer 130, which can be representative of a training algorithm. In some examples, object segmenter 116 can be trained by the trainer 130 (or a different training algorithm) using training data. The training data, in some examples, can correspond to a dataset of image-mask pairs, in some instances, billions of image-mask pairs. The dataset can be a proprietary dataset. The object detection model 128 can be trained on a number of different object classes. The objection detection model 128 can include, but not limited to, a You Only Look Once (YOLO) model, a Single Shot Detector (SSD) model, Faster Region-based Convolutional Neural Networks (R-CNN) model, or a Mask R-CNN model.

Continuing with the example of FIG. 1, the object segmenter 116 can segment the object of interest from the first frame of the scene 110 to provide a first mask 132 based on the first prompt 120. A mask can outline a shape of the object of interest. Thus, the mask can differentiate the object of interest from a background and other objects in a frame of the scene 110. The mask can be a binary image where pixels belonging to the object of interest have one value (e.g., white or 1) and all other pixels in the binary image have another value (e.g., black or 0).

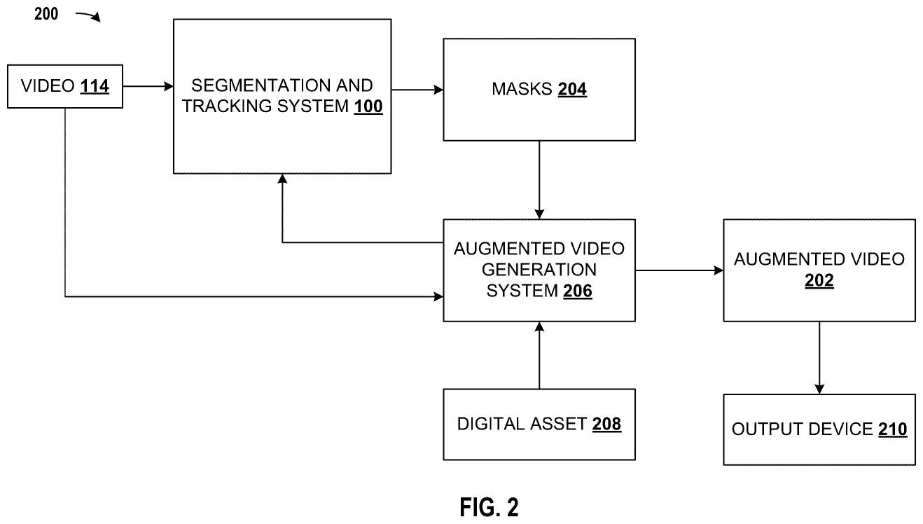

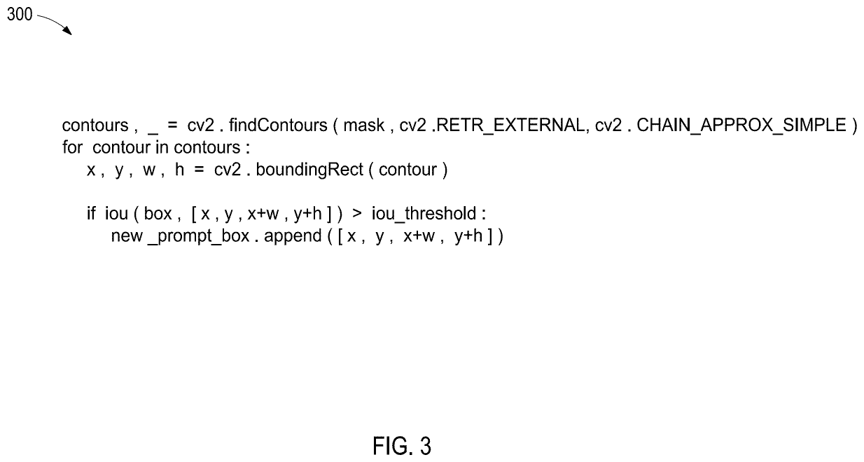

The object tracker 122 can provide a second prompt 134 for extraction (segmentation) of the object of interest in a subsequent frame of the video 114 based on the first mask 132. For example, the object tracker 122 can overlay the first mask 132 over the first frame and thus over the object of interest. The object tracker 122 can identify a contour of the object of interest in the first frame based on pixel values of the first mask 132 representing the object of interest. The object tracker 122 can generate or create a new bounding box based on the counter of the object of interest. In some examples, the object tracker 122 can determine coordinates (e.g., X and Y coordinates) for an outline of the object of interest. The object tracker 122 can use the determined coordinates for the outline of the object of interest to create the new bounding box with coordinates that more closely enclose the object of interest in contrast to the initial bounding box. FIG. 3 is an example of a portion of pseudocode 300 that can be used for creating the new bounding box. Thus, reference can be made to one or more examples of FIGS. 1-2 in the example of FIG. 3. The newly created bounding box serves as the second prompt 134 for a subsequent frame (e.g., the Frame 2).

The object tracker 122 can receive a subsequent frame from the video 114, such as a second frame of the video 114. The second frame can include the object of interest. The object tracker 122 can overlay the new bounding box over the second frame so that the object of interest is within the new bounding box. The object tracker 122 can adjust a location of the new bounding box relative to the second frame until the object of interest is within the new bounding box, or the new bounding box overlays around the object of interest. The object tracker 122 can provide a second prompt 134 based on a location of a new bounding box with the object of interest therein, that is, in response to overlaying the updating bounding box over the second frame so that the object of interest is located within the new bounding box. The second prompt 134 can provide an updated area or location of the object of interest within the second frame. Thus, the object tracker 122 can adjust a bounding box for each new frame based on an object's latest position to allow for dynamic tracking of the object of interest as the object of interest moves or changes orientation across frames. By continually updating or creating a new bounding box based on segmentation results and generating new prompts based on an object's location allows for more precise segmentation and tracking.

In some examples, the object tracker 122 can provide the new bounding box in response to determining if the new bounding box is valid. The validation of a bounding box can be determined by the object tracker 122 based on an intersection or overlap condition. The intersection or overlap condition can specify a minimum amount of intersection or overlap between a first bounding box (e.g., the initial bounding box) and a second bounding box (e.g., the new bounding box). The object tracker 122 can evaluate the first bounding box and the second bounding box to determine an amount of intersection or overlap between the first bounding box and the second bounding box. The object tracker 122 can evaluate the amount of intersection or overlap relative to the condition to determine whether the second bounding box is valid. A new bounding box that is valid is a bounding box that meets the intersection or overlap condition. In some examples, the intersection or overlap condition is a threshold. The object tracker 122 can evaluate the amount of intersection or overlap relative to the threshold (e.g., to determine whether the amount is less than or equal to the threshold).

Based on the evaluation, the object tracker 122 can flag or indicate whether the new bounding box is valid. If the new bounding box is not valid, the object tracker 122 ignores or removes the first mask 132. For example, if the object of interest disappears from a field of view (FOV) of the camera 112 the object tracker 122 deletes a tracking process of the object of interest, thereby deleting the first mask 132 (and any other related data) from the memory 108, for instance. The disappearance of the object of interest can refer to when the object of interest is far away from the camera 112 and thus too small and not trackable, outside the FOV of the camera 112, or behind one or more other objects in the scene 110.

In some examples, for light segmentation models being used as the object segmenter 116, such as FastSAM, MobileSAM, and HQ-SAM-light, results of segmentation can be noisy (spotty), such as resulting in multiple masks for the object of interest in a frame. To mitigate or reduce the noise, the object tracker 122 can merge bounding boxes that pass a noise condition. For example, segmentation of a complex object of interest can result in multiple masks (mask fragments) being created by the object segmenter 116. The object tracker 122 can create or define a bounding box for each mask fragment in a same or similar manner, as disclosed herein. The object tracker 122 can merge the bounding boxes (e.g., using coordinates defining the bounding boxes) to provide a single bounding box for the object of interest corresponding to providing the second prompt 120. In some examples, the object tracker 122 merges the bounding boxes according to the noise condition. For example, if one of the bounding boxes is located far away from remaining bounding boxes, that bounding box can be ignored by the object tracker for generation of the second prompt 120. In some examples, the object tracker 122 can use a clustering algorithm or a thresholding based on an intersection over union metric and group bounding boxes that overlap beyond a certain threshold. For each group of overlapping boxes, a new bounding box can be computed that encompasses all bounding boxes within the group. In some examples, the object tracker 122 can compute a distance between each bounding box and a centroid of a largest group of bounding boxes. The centroid can be calculated by averaging coordinates of all bounding boxes in a main bounding box cluster. If a bounding box is farther than a distance threshold from a main group this bounding box can be considered as an outlier bounding box and ignored. Bounding boxes identified as outliers (potentially noise or incorrect segmentations) by the object tracker 122 can be ignored from a final output. After merging the relevant bounding boxes and ignoring outliers, the remaining bounding boxes can be merged to provide a final bounding box for the object of interest.

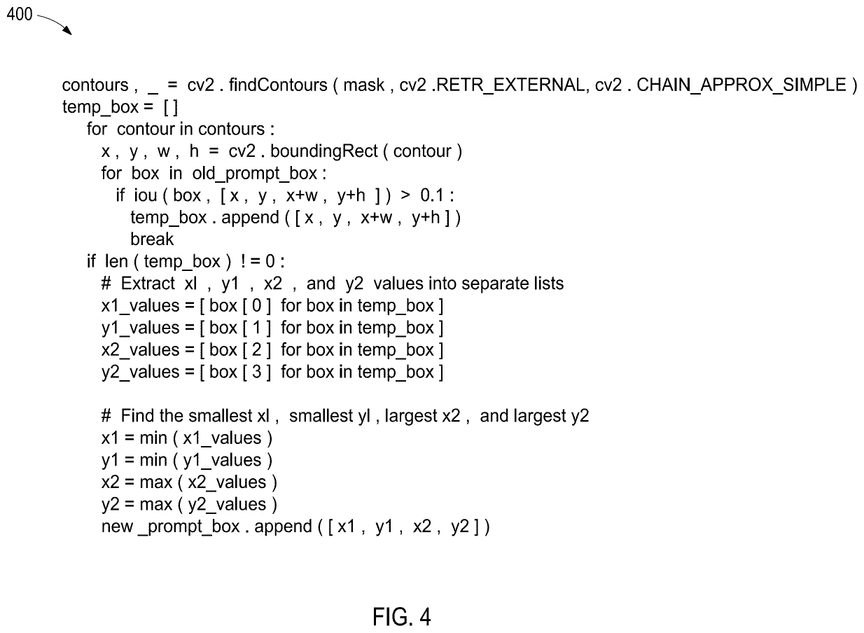

FIG. 4 is an example of a portion of pseudocode 400 that can be used for creating the new bounding box with noise mitigation or elimination. Thus, reference can be made to one or more examples of FIGS. 1-3 in the example of FIG. 4.

In some examples, the object tracker 122 can refine a bounding box. For instance, the object tracker 122 can track a motion of a bounding box for an object of interest across frames of the video 114. Tracking the motion of the bounding box refers to tracking monitoring or tracking a movement of the object of interest in the scene across frames of the video 114 and adjusting a size and/or position of the bounding box accordingly. The object tracker 122 can estimate the motion of the object of interest in the scene 110 and generate a new, appropriately placed, bounding box for each frame based on this estimation. By predicting a future position of the object of interest in a subsequent frame allows the object tracker 122 to more efficiently track the object of interest.

Continuing with the example of FIG. 1, the object segmenter 116 can segment the object of interest from the second frame based on the second prompt 134 to provide a second mask 136 (an updated mask), which can be processed (or used) by the object tracker 122 in a same or similar manner as the first mask, as disclosed herein, to provide a new prompt for segmentation the object of interest in a successive frame (e.g., Frame 3). The system 100 can track and segment the object of interest according to one or more examples, as disclosed herein, as long as the object of interest remains present in the video 114.

Accordingly, the object segmenter 116 can provide masks based on one or more bounding boxes from the object tracker 122. The object tracker 122 can use masks from segmentation to provide new bounding boxes, which serve as input prompts. Because the object segmenter 116 can segment regions even when a prompt is slightly inaccurate allows the segmentation and tracking system 100 to self-correct the prompt, which provides accurate tracking of the object of interest across the video 114 as a process moves from one frame to a next frame of the video 114.

FIG. 2 is a block diagram of a system 200 for generating augmented video 202. The system 200 can be used during film production. For example, the augmented video 202 can be provided during CGI (VFX) filming. The system 200 includes the segmentation and tracking system 100, as shown in FIG. 1. Thus, reference can be made to one or more examples of FIG. 1 in the example of FIG. 2. For example, a video 114 of the scene 110 can be received by the system 100. The video can include frames corresponding to still images of the scene 110. In some examples, the frames include a first set of frames of the scene 110 generated during a pre-action phase of the scene 110 and a second set of frames of the scene 110 generated during an action-phase of the scene. Thus, the video 114 can contain frames that had been obtained during a preparatory moment before official start of filming the scene 110.

The system 100 can be used to provide masks 204 for each object of interest in the scene 110 according to one or more examples, as disclosed herein. In some examples, a mask can be provided based on a frame from the first set of frames and another mask can be provided based on a frame from the second set of frames. Each mask of the masks 204 can outline a shape of the object of interest in the scene 110 and thus can indicate an area where the object of interest is located in a frame of the video 114. The system 100 can output the masks 204 for the object of interest in the frames. The masks 204 can be provided to an augmented video generation system 206. The augmented video generation system 206 can be a pre-viz system, as disclosed in the '175 Patent. In some examples, the augmented video generation system 206 includes the system 100, as shown in FIGS. 1-2. The augmented video generation system 206 can provide the augmented video 202 based on the masks 204 for each object of interest from the system 100, a digital asset 208, the video 114, and other relevant data as needed for providing the augmented video 202. In some examples, video footage from a different camera than the camera 112 used for providing the video 114 is used by the augmented video generation system 206. Example digital assets can include, but not limited to, three-dimensional (3D) models of objects, characters, and/or environment, textures applied to 3D models, digital animations that involve movement of the 3D models, visual effects, etc.

The augmented video generation system 206 can use the masks 204 for occlusion of the object of interest in the scene 110. The augmented video generation system 206 can integrate the digital asset 208 into the video 114 (or a portion thereof) to provide the augmented video 202 in which the object of interest is occluded by the digital asset 208, or the digital asset 208 is occluded by the object of interest. For example, the augmented video generation system 206 can provide the augmented video 202 with parts of the digital asset 208 blocked from view, the digital asset 208 appearing to exist behind the object of interest, or with the digital asset 208 blocking the object of interest based on the masks 204. The augmented video 202 can be outputted on an output device 210, for example, during film production. The output device 612 can include one or more stationary displays (e.g., televisions, monitors, etc.), viewfinders, one or more displays of portable or stationary devices, and/or the like.

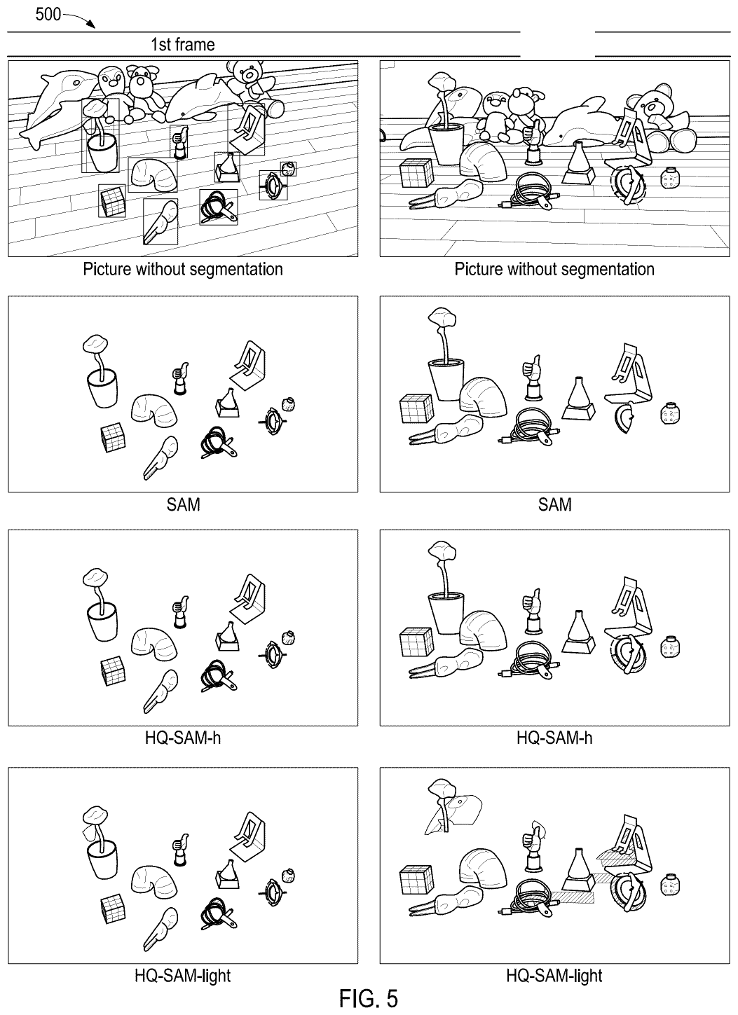

In some examples, to evaluate and compare different models, a video of objects with various shapes which are supposed to impose some challenges for prompting the segmentation was prepared in an experiment. Objects were added in a background to increase a challenge as well. The bounding boxes of the objects by hand as shown in the top-left plot in the table of Figures, Table 1, as shown in FIG. 5. FIG. 5 also depicts a last frame of the video as a top-right plot. In the Table 1 of FIG. 5, all pictures at the left are the first frame and right are the last frame. A first row in FIG. 5 are original pictures. Additionally, the initial bounding boxes were added in the first frame. The second row in FIG. 5 are results from SAM, and the third and fourth rows are from HQ-SAM-h and HQ-SAM-light, respectively.

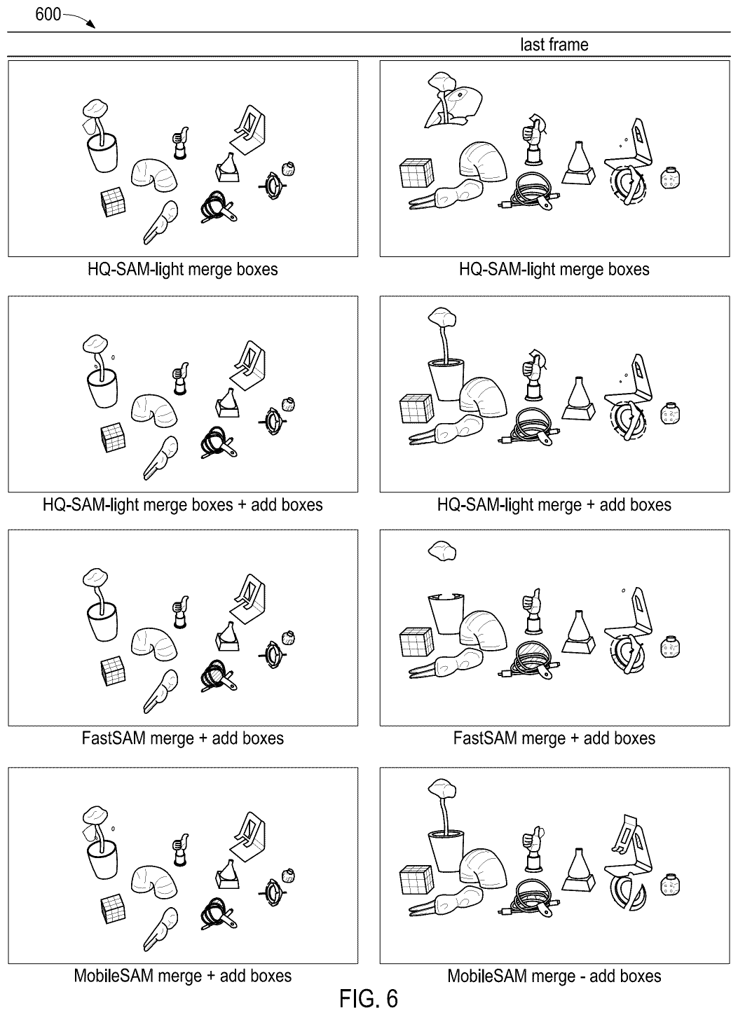

Then, the system 100 can be used to apply a segmentation and tracking method as disclosed herein on the video using different models and the results of the first and last frames in Table. 1, are shown in FIG. 5, and Table 2, are shown in FIG. 6. Table 2 is a continuation of Table 1. The first row of Table 2 shows the results of HQ-SAM-light with the step of merging small boxes. Then, the bounding box for the plant was replaced with three boxes and results are shown in the second row. The procedure can be repeated but using FastSAM and MobileSAM and the results are shown in third and fourth row, respectively. Note that the bounding boxes in the first row of FIG. 5 are the bounding boxes for all the methods except the last three rows. For the last three rows, one of the bounding boxes is replaced with three bounding boxes as shown in FIG. 5 to help define a shape of an object of interest. By comparison, it is apparent that large models (e.g., SAM and HQ-SAM-h) can recognize and track a proper shape of the object of interest all the way to the last frame without these additional boxes.

Using a SAM, as the object segmenter 116 allows for tracking objects of interest to an end of the video. Using an HQ-SAM-h as the object segmenter 116 can provide an improved performance in some details compared to SAM. Using HQ-SAM-light, deviation for the object with other objects in the background was observed. Also, a floor area was included as part of the objects during the tracking process. Once the step of merging boxes was added, the noise related to the floor confusion was suppressed. To help disentangling with the background objects, the objects were defined with complicated shapes with multiple boxes. This step does help for the light models. FastSAM part of the plant (one of the objects) is missing in the last frame even though multiple boxes were provided. The edges of segmentation are wiggling. The wiggling might not be critical for some real-time applications, but the missing segmentation could be a concern. The performance from the MobileSAM is as good as the one from HQ-SAM-light. It is reasonable since HQ-SAM light uses the same image encoder as MobileSAM. The MobileSAM model can be as fast as 80 FPS) and HQ-SAM-light can be better than 40 FPS. Accordingly, the systems and methods as disclosed herein are sufficient for performing real-time segmentation and tracking objects.

Thus, a comparative analysis of various SAM variants, such as FastSAM, MobileSAM, and light version of HQ-SAM, yielded insights into their performance. MobileSAM and HQ-SAM-light demonstrated remarkable speed and efficiency without compromising on segmentation quality, rendering it highly suitable for real-time applications. Furthermore, certain refinements like using more bounding boxes for objects with complicated shapes could improve the segmentation output, especially for light models.

Accordingly, examples are disclosed herein illustrating the limitations of current segmentation and tracking methods in AR applications, such as in film production. SAMs can be used for real-time segmentation and tracking of a wide range of objects. Traditional approaches have often relied on object detection models, which introduce performance bottlenecks and limitations in a diversity of objects that can be segmented. By eliminating the use of object detection models (e.g., for object detection in subsequent frames), the systems and methods, as disclosed herein, allows for achieving real-time segmentation and tracking with high accuracy. Accordingly, real-time segmentation and tracking can be achieved by using the systems and methods, as disclosed herein, and allows for practical application of SAMs, especially in a fast-paced and demanding environment of film production. It opens up new avenues for enhancing the realism and interaction of virtual assets with the real world, thereby contributing to a future advancement of AR technologies.

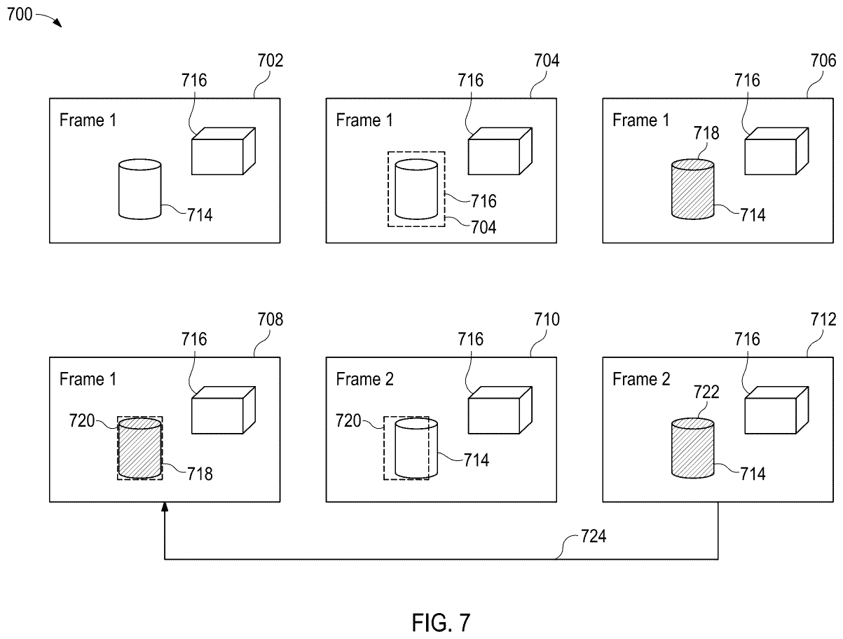

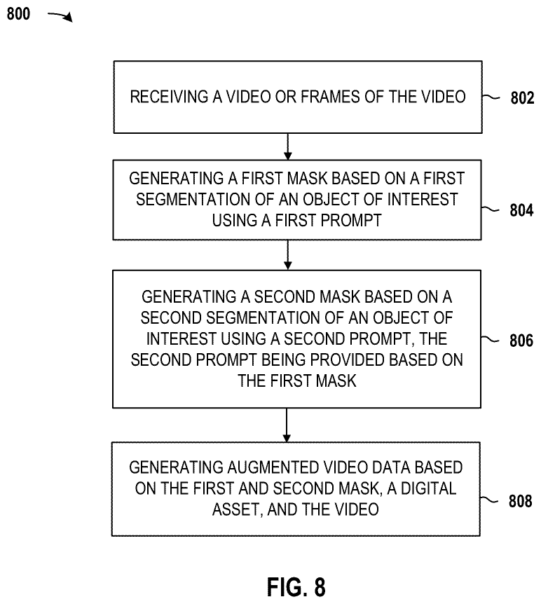

In view of the foregoing structural and functional features described above, example methods will be better appreciated with reference to FIGS. 7-8. While, for purposes of simplicity of explanation, the example methods of FIGS. 7-8 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the method.

FIG. 7 is an example of a method 700 of segmentation and tracking of an object in video of a scene, such as the scene 110, as shown in FIG. 1. Thus, reference can be made to one or more examples of FIGS. 1-6 in the example of FIG. 7. One or more steps of the method 700 can be implemented by the system 100, as shown in FIGS. 1-2.

The method 700 can begin at 702 with setting up the scene (e.g., the scene 110, as shown in FIG. 1) and capturing video (e.g., the video 114, as shown in FIG. 1) using a video camera (e.g., the camera 112, as shown in FIG. 1). In other or additional examples, at 702, a first frame (identified as “Frame 1” in the example of FIG. 7) of the video can be received (e.g., at the object tracker 122, as shown in FIG. 1). The first frame includes a first object 712 and a second object 714. At 704, a bounding box 716 can be created (e.g., by the object tracker 122) to overlay the first frame so that the first object 712 is within the bounding box 716, as shown in FIG. 7. The first object 712 can be referred to as an object of interest. In some examples, at 704, a first prompt (e.g., the first prompt 120, as shown in FIG. 1) can be provided based on the bounding box 716. At 706, the first object 712 is segmented (e.g., by the object segmenter 116, as shown in FIG. 1) based on the first prompt to provide a first mask 718 (e.g., the first mask 132, as shown in FIG. 1).

At 708, a second (or new) bounding box 720 for the first object 712 in the first frame based on the mask 718 is created using the first mask 718 (e.g., by the object tracker 122). At 710, the second bounding box 720 is overlaid (e.g., by the object tracker 122) over a second frame (identified as “Frame 2” in the example of FIG. 7) of the video so that the object of interest is within the second bounding box 720. The second frame includes the first object 712 and the second object 714, as shown in FIG. 7. In the second frame, the first object 712 is in a different location in the scene than in the first frame. For example, the second bounding box 720 can be adjusted (e.g., by the object tracker 122) until the object of interest is within the new bounding box at step 708. In some examples, at step 702, a second prompt (e.g., the second prompt 134, as shown in FIG. 1) is generated (e.g., by the object tracker 122) for segmentation of the object of interest from the second frame based on the second bounding box 720.

At 710, the new bounding box 720 is overlaid over the second frame and adjusted until the first object 712 is within the new bounding box 720. A second prompt (e.g., the second prompt 134, as shown in FIG. 1) can be provided based on the new bounding box 720, in some examples, at 710. At 712, the first object 712 in the second frame is segmented using the second prompt to provide a second mask 722 (e.g., the second mask 136, as shown in FIG. 1). The method 700 can proceed at step 724 back to step 708 and steps 708-712 can be repeated for one or more subsequent frames that include the first object 712. For example, at step 708, a third bounding box for the first object 712 in the second frame is created using the second mask 722, and the method 700 can proceeds to steps 710-710 and loop back to step 708 for any remaining frames that include the first object 712 (the object of interest).

FIG. 8 is an example of a method 800 for providing augmented video according to one or more examples, as disclosed herein. The method 800 can be implemented by the system 200, as shown in FIG. 2. Thus, reference can be made to one or more examples of FIGS. 1-7 in the example of FIG. 8.

The method 800 can begin at 802 with receiving (e.g., at the system 100, as shown in FIGS. 1-2) a video (e.g., the video 114, as shown in FIG. 1) of a scene (e.g., the scene 110, as shown in FIG. 1), or frames of the video. At 804, a first mask (e.g., the first mask 132, as shown in FIG. 1) for each object of interest can be generated (e.g., by the system 100) based on a first segmentation of each object of interest using a first prompt (e.g., the first prompt 120, as shown in FIG. 1) from a first frame of the video. At 806, a second mask (e.g., the second mask 136, as shown in FIG. 1) for each object of interest can be generated (e.g., by the system 100) based on the segmentation of each object of interest using a second prompt (e.g., the second prompt 134, as shown in FIG. 1) from a second frame of the video. The second prompt is provided based on the first mask. At 808, augmented video (e.g., the augmented video 202) can be provided (e.g., by the augmented video generation system 206, as shown in FIG. 2) based on at least the first and second masks (e.g., the masks 204, as shown in FIG. 2) and a digital asset (e.g., the digital asset 208, as shown in FIG. 2). The digital asset can be animated and thus, the augmented video can be generated with the digital asset animated therein. For example, the augmented video data can be generated during the filming or production based on video footage of an environment (e.g., the scene) and the digital asset animation. The augmented video data can be provided to one or more displays for viewing.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

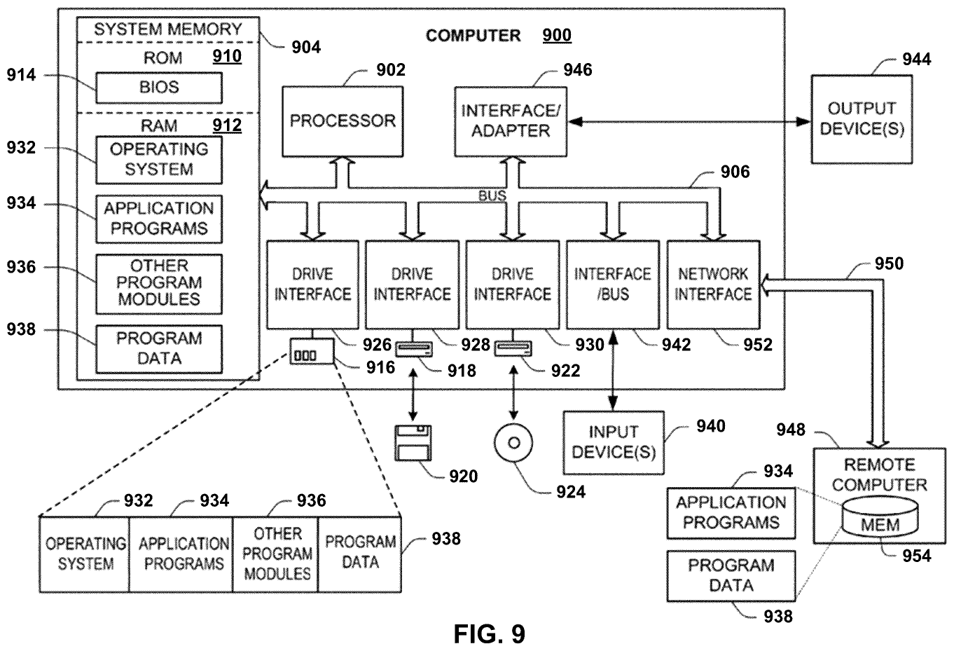

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 9. Thus, reference can be made to one or more examples of FIGS. 1-8 in the example of FIG. 9.

In this regard, FIG. 9 illustrates one example of a computer system 900 that can be employed to execute one or more embodiments of the present disclosure. Computer system 900 can be implemented on one or more general purpose networked computer systems, embedded computer systems, routers, switches, server devices, client devices, various intermediate devices/nodes or standalone computer systems. Additionally, computer system 900 can be implemented on various mobile clients such as, for example, a personal digital assistant (PDA), laptop computer, pager, and the like, provided it includes sufficient processing capabilities.

Computer system 900 includes processing unit 902, system memory 904, and system bus 906 that couples various system components, including the system memory 904, to processing unit 902. Dual microprocessors and other multi-processor architectures also can be used as processing unit 902. System bus 906 may be any of several types of bus structure including a memory bus or memory controller, a peripheral bus, and a local bus using any of a variety of bus architectures. System memory 904 includes read only memory (ROM) 910 and random access memory (RAM) 912. A basic input/output system (BIOS) 914 can reside in ROM 910 containing the basic routines that help to transfer information among elements within computer system 900.

Computer system 900 can include a hard disk drive 916, magnetic disk drive 918, e.g., to read from or write to removable disk 920, and an optical disk drive 922, e.g., for reading CD-ROM disk 924 or to read from or write to other optical media. Hard disk drive 916, magnetic disk drive 918, and optical disk drive 922 are connected to system bus 906 by a hard disk drive interface 926, a magnetic disk drive interface 928, and an optical drive interface 930, respectively. The drives and associated computer-readable media provide nonvolatile storage of data, data structures, and computer-executable instructions for computer system 900. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 912, including operating system 932, one or more application programs 934, other program modules 936, and program data 938. In some examples, the application programs 934 can include one or more modules (or block diagrams), or systems, as shown and disclosed herein. Thus, in some examples, the application programs 934 can include the system 100, as shown in FIG. 1, or one or more systems, as disclosed herein.

A user may enter commands and information into computer system 900 through one or more input devices 940, such as a pointing device (e.g., a mouse, touch screen), keyboard, microphone, joystick, game pad, scanner, and the like. These and other input devices are often connected to processing unit 902 through a corresponding port interface 942 that is coupled to the system bus, but may be connected by other interfaces, such as a parallel port, serial port, or universal serial bus (USB). One or more output devices 944 (e.g., display, a monitor, printer, projector, or other type of displaying device) is also connected to system bus 906 via interface 946, such as a video adapter.

Computer system 900 may operate in a networked environment using logical connections to one or more remote computers, such as remote computer 948. Remote computer 948 may be a workstation, computer system, router, peer device, or other common network node, and typically includes many or all the elements described relative to computer system 900. The logical connections, schematically indicated at 950, can include a local area network (LAN) and a wide area network (WAN). When used in a LAN networking environment, computer system 900 can be connected to the local network through a network interface or adapter 952. When used in a WAN networking environment, computer system 900 can include a modem, or can be connected to a communications server on the LAN. The modem, which may be internal or external, can be connected to system bus 906 via an appropriate port interface. In a networked environment, application programs 934 or program data 938 depicted relative to computer system 900, or portions thereof, may be stored in a remote memory storage device 954.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

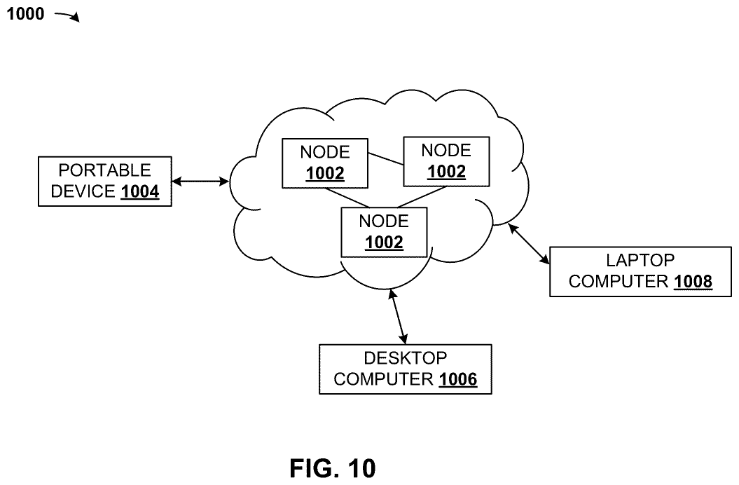

FIG. 10 is an example of a cloud computing environment 1000 that can be used for implementing one or more modules and/or systems in accordance with one or more examples, as disclosed herein. Thus, reference can be made to one or more examples of FIGS. 1-9 in the example of FIG. 10. As shown, cloud computing environment 1000 can include one or more cloud computing nodes 1002 with which local computing devices used by cloud consumers (or users), such as, for example, personal digital assistant (PDA), cellular, or portable device 1004, a desktop computer 1006, and/or a laptop computer 1008, may communicate. The computing nodes 1002 can communicate with one another. In some examples, the computing nodes 1002 can be grouped (not shown) physically or virtually, in one or more networks, such as Private, Community, Public, or Hybrid clouds, or a combination thereof. This allows the cloud computing environment 1000 to offer infrastructure, platforms and/or software as services for which a cloud consumer does not need to maintain resources on a local computing device. The devices 1004-1008, as shown in FIG. 10, are intended to be illustrative and that computing nodes 1002 and cloud computing environment 1000 can communicate with any type of computerized device over any type of network and/or network addressable connection (e.g., using a web browser). In some examples, the one or more computing nodes 1002 are used for implementing one or more examples disclosed herein relating to root-source identification. Thus, in some examples, the one or more computing nodes can be used to implement modules, platforms, and/or systems, as disclosed herein.

In some examples, the cloud computing environment 1000 can provide one or more functional abstraction layers. It is to be understood that the cloud computing environment 1000 need not provide all of the one or more functional abstraction layers (and corresponding functions and/or components), as disclosed herein. For example, the cloud computing environment 1000 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 1000 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 1000 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1000, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 1000 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 1000 can provide a workloads layer that provides examples of functionality for which the cloud computing environment 1000 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 1000.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1. A computer-implemented method comprising:
receiving frames of a scene, the frames including an object;
generating a first bounding box so that the object in a first frame of the frames is within the first bounding box;
providing a first prompt based on the first bounding box;
segmenting the object from the first frame based on the first prompt to provide a first mask;
generating a second bounding box so that the object in a second frame of the frames is within the second bounding box based on the first mask;
providing a second prompt based on the second bounding box; and
segmenting the object from the second frame based on the second prompt to provide a second mask.

2. The computer-implemented method of claim 1, wherein generating the second bounding box comprises:
overlaying the first mask over the first frame to overlay the object;
identifying a contour of the object in the first frame based on pixel values of the first mask representing the object; and
creating the second bounding box based on the counter of the object.

3. The computer-implemented method of claim 2, wherein creating the second bounding box comprises overlaying the second bounding box over the second frame so that the object is within the second bounding box, the second prompt being generated based on a location of the second bounding box when the object is located therein.

4. The computer-implemented method of claim 3, wherein overlaying comprises adjusting the second bounding box until the object is located therein.

5. The computer-implemented method of claim 1, wherein the second bounding box is provided in response to determining that the second bounding box is valid.

6. The computer-implemented method of claim 5, further comprising determining that the second bounding box is valid based on an evaluation of the first and second bounding boxes using an intersection or overlap condition.

7. The computer-implemented method of claim 6, wherein the intersection or overlap condition specifies an amount of intersection or overlap between the first and second bounding boxes.

8. The computer-implemented method of claim 1, generating augmented video comprising a video that has been augmented with a digital asset based on at least the first and second masks.

9. The computer-implemented method of claim 8, wherein the augmented video is generated during film production of a scene, the scene including the object.

10. The computer-implemented method of claim 1, wherein the object is segmented from the first and second frames using a segment anything model (SAM).

11. The computer-implemented method of claim 10, wherein the SAM is fast SAM (FastSAM), a mobile (MobileSAM), or a high-quality SAM (HQ-SAM).

12. The computer-implemented method of claim 1, wherein the first bounding box is generated using an object detection model or based on user input at an input device and the second bounding box is not.

13. The computer-implemented method of claim 12, further comprising generating a graphical user interface (GUI) with the first frame and graphical elements that are manipulated by a user to generate the first bounding box around the object in the first frame.

14. The computer-implemented method of claim 13, further comprising outputting the GUI on a display.

15. A computer-implemented method comprising:
receiving a video of a scene or frames of the video of the scene;
generating a first mask for an object in a first frame of the frames, the first mask being generated based on a first segmentation of the object from the first frame using a first prompt;
generating a second mask for the object in a second frame of the frames, the second mask being generated based on a second segmentation of the object from the second frame using a second prompt, the second prompt being generated based on the first mask; and
generating augmented video based on the video, the first and second mask, and a digital asset.

16. The computer-implemented method of claim 15, wherein the digital asset is animated, and the augmented video is provided with the digital asset animated therein.

17. The computer-implemented method of claim 16, wherein the augmented video is generated during film production of a scene, the scene including the object.

18. The computer-implemented method of claim 15, wherein the object is segmented from the first and second frames using a segment anything model (SAM), the SAM comprising one of a fast SAM (FastSAM), a mobile (MobileSAM), and a high-quality SAM (HQ-SAM).

19. A system comprising:
one or more computing platforms configured to:
receive frames of a scene, the frames including an object;
generate a first bounding box so that the object in a first frame of the frames is within the first bounding box;
provide a first prompt based on the first bounding box;
segment the object from the first frame based on the first prompt to provide a first mask;
generate a second bounding box so that the object in a second frame of the frames is within the second bounding box based on the first mask;
provide a second prompt based on the second bounding box; and
segment the object from the second frame based on the second prompt to provide a second mask, wherein the object is segmented from the first and second frames using a segment anything model (SAM).

20. The system of claim 19, the one or more computing platforms configured to generate augmented video comprising a video that has been augmented with a digital asset based on at least the first and second masks, the augmented video is generated during film production of a scene, the scene including the object.
